(19) United States
(12) Patent Application Publication
(10) Pub. No.: US 2012/0064500 A1
(43) Pub. Date: Mar. 15, 2012

(54) INSTRUCTION AND TRAINING SYSTEM, METHODS, AND APPARATUS

(75) Inventors: Joshua Waitzkin, New York, NY (US); Marcelo Garcia Vespucio, New York, NY (US); Maria Tatiana Tognini Garcia, New York, NY (US); Gregory Tulchinsky, Brooklyn, NY (US)

(73) Assignee: MGinaction LLC, New York, NY (US)

(21) Appl. No.: 12/880,305

(22) Filed: Sep. 13, 2010

(51) Int. Cl. G09B 7/00

(52) U.S. Cl. 434/350

(57) ABSTRACT

A system, methods, and apparatus for instruction and training are disclosed. In an example embodiment, a plurality of instructional videos and actual performance videos relating to a plurality of techniques are stored and organized according to technique. A user interface displays a first video and a dynamic link. A user may view the first video on a first technique, which is an instructional video or an actual performance video. If the user has viewed an instructional video, the user may select and access the dynamic link to view a second video related to the first technique, which is an actual performance video. If the user has viewed an actual performance video, the user may select and access the dynamic link to view a second video related to the first technique, which is an instructional video.

### BACKGROUND

Recently, there has been a desire for increased flexibility in instructional and training systems and methods. People wanting or needing to learn or receive instruction, such as students or trainees, and people wanting to teach or provide instruction or training, instructors or trainers, generally prefer the ability to quickly and efficiently transfer knowledge from the instructor to the student. For example, remote education and remote training have gained in popularity, typically using the internet to provide educational, instructional, or training materials to students or trainees. Also, various methods of allowing student interaction between an instructor, trainer, or tutor and one or more students or trainees, or amongst students and trainees, have been provided to further add to the efficiency and quality of teaching and learning the skills and knowledge, or the particular techniques, at hand. Existing systems may allow students, or users, to browse or search instructional content, receive feedback on progress in the form of quizzes or other analysis of the student, create notes for review, and various other means for increasing the usefulness of the instructional or training systems.

### SUMMARY

The present disclosure provides a new and innovative system, methods and apparatus for instruction and training. In one example embodiment, a plurality of instructional videos and actual performance videos relating to a plurality of techniques are stored and organized according to technique. A user interface displays at least a first video and a dynamic link. A user may view the first video on a first technique, which is an instructional video or an actual performance video. If the user has viewed an instructional video, the user may select and access the dynamic link to view a second video related to the first technique, which is an actual performance video. If the user has viewed an actual performance video, the user may select and access the dynamic link to view a second video related to the first technique, which is an instructional video.

In another example embodiment, a plurality of actual performance videos relating to a plurality of techniques are stored and organized according to technique. A user interface displays one or more videos and dynamic links. For example, a user may view a video relating to a first technique, which includes one or more actual performances of the first technique without any other techniques preceding or following the first technique. The user may select and access the dynamic link to view another video related to the first technique, which includes an actual performance of the first technique in a sequence with a plurality of other techniques. For example, a user may view a video relating to a first technique, which includes an actual performance of the first technique in a sequence with a plurality of other techniques. The user may select and access the dynamic link to view another video related to the first technique, which includes one or more actual performances of the first technique without any other techniques preceding or following the first technique.

In a preferable example embodiment, users are allowed to flow back and forth between theory and practice in the learning process. For example, a user may first watch instructional material on a technique, and may then watch one or many examples of that technique being executed in live action. Similarly, for example, a user may be watching a live action sequence and, at any time, may click a dynamic link to view instructional material on a technique that they would like to explore more deeply. In live action, there are often many subtle variations, so the ability to watch many concisely edited live action embodiments of something taught in an instructional video may greatly enhance the learning curve with real-life examples.

Additional features and advantages of the disclosed method and apparatus are described in, and will be apparent from, the following Detailed Description and the Figures.

### BRIEF DESCRIPTION OF THE FIGURES

FIG. 1 is a high level block diagram of an example network communicating system, according to an example embodiment of the present invention.

FIG. 2 is a detailed block diagram showing an example of a computing device, according to an example embodiment of the present invention.

FIGS. 3a and 3b provide an illustration of an example user interface, according to an example embodiment of the present invention.

FIGS. 4a and 4b include a flowchart illustrating an example process for instructing or training, according to an example embodiment of the present invention.

FIG. 5 is a flowchart illustrating an example process for instructing or training, according to an example embodiment of the present invention.

FIGS. 6a and 6b provide example screen shots of an example user interface, according to an example embodiment of the present invention.

FIG. 7 is a block diagram showing an example data architecture, according to an example embodiment of the present invention.

### DETAILED DESCRIPTION OF EXAMPLE EMBODIMENTS

The present disclosure relates in general to educational or training systems, and, in particular, to a system, methods, and apparatus for instruction and training.

Existing instruction and training systems and methods provide certain challenges to students attempting to learn, and also, instructors attempting to teach. For example, instructors and students may prefer in person communication, or live one-on-one communication, which may allow for dynamic interaction between the student or trainee and the instructor or trainer. Such dynamic interaction may be used to optimally concentrate on appropriate materials in an appropriate manner, thus, optimizing the instructive process. The existing instruction and training systems and methods present challenges for instructors and students endeavoring to teach and learn in a dynamic interactive manner. Moreover, the prior art fails to provide a sufficient solution for the above described challenges.

Briefly, in an example embodiment, a system is provided which allows a user to browse, search, and view videos to learn some subject or skill set, such as the martial art of Brazilian Jiu Jitsu, using an online training and instruction website. For example, the system may include a host server which stores training content including videos, which are available to the user on the website, where the user may navigate to desired content to learn particular techniques. For example, the videos may include instructional videos and actual performance videos organized by content which allows the user to easily access materials on desired techniques on the website. Instructional videos may include various forms of instruction covering many topics or techniques. Actual performance videos may include live performances, for example, of an expert in the field applying various techniques. The user may navigate between the instructional videos and actual performance videos using dynamic links, which may be provided according to the presently displayed content on the website.

The videos may be organized into various helpful categories, for example, instructional videos may be grouped as fundamental or advanced, which may guide the user's decision on what to learn according to the user's present skill set. Also, for example, actual performance videos may be grouped as sparring performances or in action performances, which may be used by the user for different purposes. For example, a user may watch a world class professional work various techniques in a sparring session until a specific technique catches the user's eye, at which time, the user may select a dynamic link displayed on the website to view relevant related content on that technique. For example, the user may watch an instructional video explaining how the technique is performed, or the user may watch several actual performances of that technique in action. When the user is watching an instructional video, a dynamic link may be accessed to view actual performances of the instructed technique, such as in action sequences of that technique, which may provide a deep understanding of that technique applied in many different situations, or sparring sessions of that technique which may provide insight as to the situations which commonly give rise to that technique, and/or typical transitions to and from that technique. Thus, in this example embodiment, by dynamically linking the instructional video content and the actual performance video content, users may dynamically link between instructional videos and actual performance videos to learn Brazilian Jiu Jitsu in a natural and fluid manner.

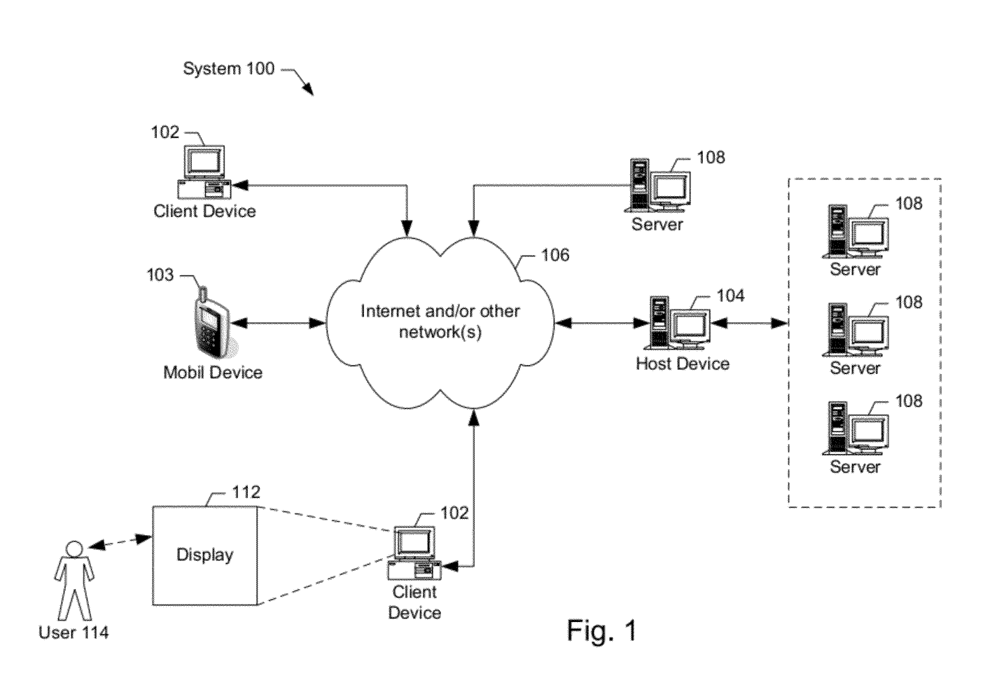

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection.

Each host device 104 stores one or more of a plurality of files, programs, databases, and/or web pages in one or more memories for use by the client devices 102. A host device 104 may be configured according to its particular operating system, applications, memory, hardware, etc., and may provide various options for managing the execution of the programs and applications, as well as various administrative tasks.

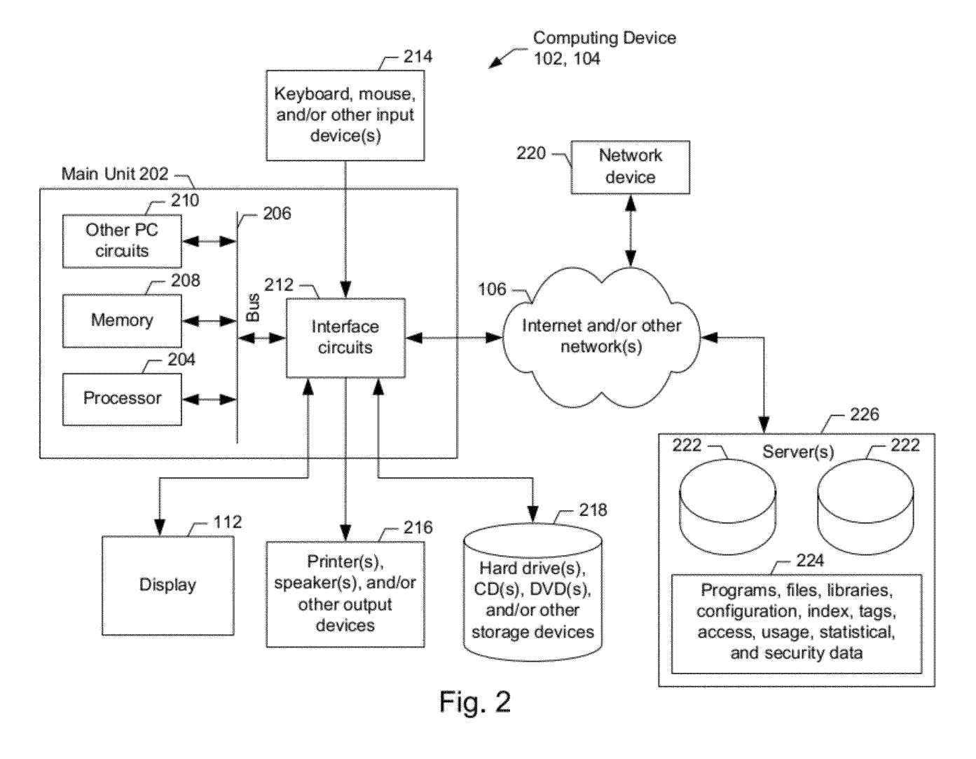

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, etc., and may provide various outputs in response to the user inputs, such as still images, videos, audio, animations, and text.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data, for example, video data stored in one or more data repository 222. However, a server 226 may include any kind of data 224 including programs, files, libraries, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, etc. Access to a computing device 102, 104 can be controlled by appropriate security software or security measures. An individual users' access can be defined by the computing device 102, 104 and limited to certain data and/or actions. Accordingly, users 114 of the system 100 may be required to register with one or more computing devices 102, 104. For example, registered users 114 may be able to manipulate data, such as by tagging video content, providing discussion text or notes, submitting or uploading video content, rating content, suggesting content to other users 114, etc.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

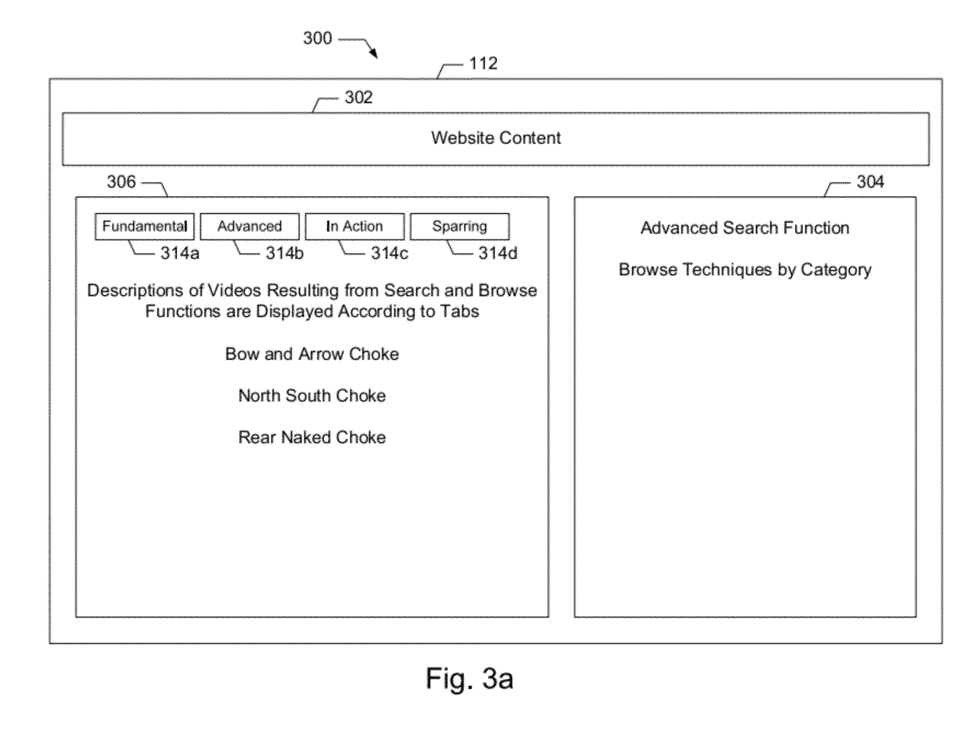

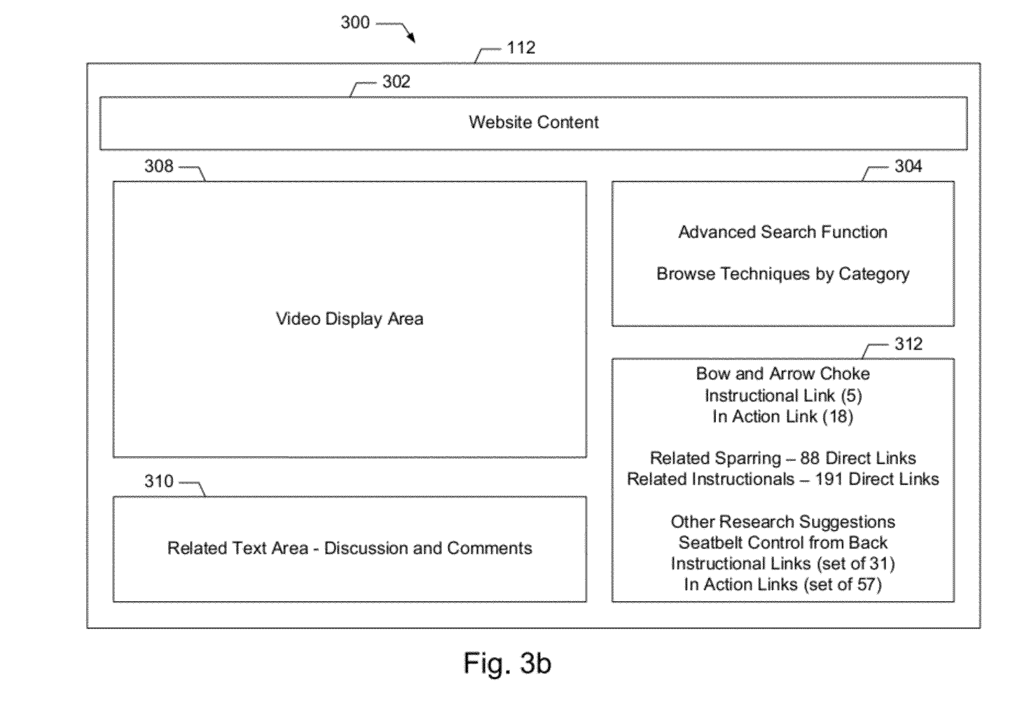

FIG. 3a and FIG. 3b provide illustrate of an example user interface 300. In this example, the user interface 300 is illustrated as a web page which provides instruction or training in martial arts or self defense, for example purposes, Brazilian Jiu Jitsu. It should be appreciated that the same system may apply to wrestling, judo, boxing, karate, etc. It should also be appreciated that the user interface 300 may similarly provide instruction for various other skill sets, including various vocational applications, recreational applications, and competitive applications, for example, sports and games. Further, it should be appreciated that a user interface 300 may be implemented using both a visual display of information (e.g., on display 112) as well as audio or other output stimuli for an improved user experience. Typically, a web browser is used to display a web page on a client device 102. For exemplary purposes, the visual aspect of the user interface 300 is discussed in detail with respect to martial arts or self defense techniques, and more particularly, as an example, Brazilian Jiu Jitsu.

A user may view the example user interface 300 on the display 112. The example user interface 300 includes a website content area 302, a search and browse area 304, a video description area 306, a video display area 308, a text area 310, and a dynamic link area 312. It should be appreciated that a web page layout may allocate the space for each section of the user interface 300 according to the specific type of content which will be displayed. Further, it should be appreciated that advertisements and various other sections may readily be incorporated in a user interface 300, and that the example areas explained may be combined or modified in various ways. Also, it should be appreciated that the user interface 300 may not only visually displayed on the display 112, but may also be provided via other output mechanisms such as speakers 216, and uses input devices 214 such as a keyboard and mouse.

As illustrated in FIG. 3a, the website content section 302 includes content typically found on a website, such as announcements information and navigational links to various portions of a website (e.g., Information, My Page, Shop, Contact Us). The search and browse area 304 allows a user 114 to enter search terms or browse to find techniques that the user 114 is interested in. For example, the user 114 may enter a search term, for example, a particular type of technique, position, or situation, such as “choke” which will provide results limited to techniques related to chokes. Also, the search and browse area 304 allows a user 114 to browse through techniques, for example, by providing a menu which may be organizing by position, each including sub-headings including various categories of techniques, including transitions, attacking moves, defenses to attacks or transitions, etc. The search and browse area 304 allows a user to navigate to a desired starting point for researching techniques.

The video description area 306 provides results based on the users' searching or browsing through the search and browse area 304. Accordingly, when a user 114 enters a search term, such as “choke,” the video description area 306 may provide a description for each video segment that is returned from the search. The search results, or browsing results, may be organized according to tabs as illustrated as tab 314a, tab 314b, tab 314c, and tab 314d. For example, tab 314a may be a Fundamental tab including instruction on fundamental techniques, tab 314b may be an Advanced tab including instruction on advanced techniques, tab 314c may be an In Action tab including short clips of actual performances of the searched for technique without techniques which are not searched for, and tab 314d may be a Sparring tab including actual performances of the searched for technique in sequence with other preceding and following techniques from sparring or competitive matches. Other tabs, such as a discussion tab, may be included for organizing content available to the user 114. Further, any other suitable means of organization may be used to display search or browsing results.

If the user 114 is seeking an instructional video, the instructional tabs 314a and 314b may be referenced. If the user 114 is an advanced practitioner, the user may look to the advanced tab and see results of advanced instruction relating to the chosen technique or position, e.g., chokes. The user 114 may select a particular technique from the list of described videos in the video description area 306, for example, a bow and arrow choke. The video may be described using, for example, a thumbnail image and a short textual description of the technique. The description may include other information such as a number of times a video was viewed, a rating, a number of related videos, etc. It should be appreciated that the video description area will include as many or few results as are dictated by the amount of content fitting the search criteria provided by the user 114.

If the user 114 is unfamiliar with a technique, the user 114 may start by selecting a fundamental instructional video. Accordingly, based on the user's own skill set, knowledge, and abilities, the user 114 may control the level of instruction received in the videos. Once a fundamental technique is understood, the user may move on to an advanced technique if further instruction is desired for the technique at hand.

If the user 114 is seeking an actual performance video, the actual performance tabs 314c and 314d may be referenced. The user may select specified techniques from the In Action tab 314c, such as Bow and Arrow Choke from Back, or Inverted North South Choke, or Rear Naked Choke. If the user wishes to see several applications of the rear naked choke from live sparring or competitive matches, the user 114 selects videos from the In Action tab 314c. The In Action tab 314c provides the user with the ability to view numerous applications of the same technique, performed live in real competitive circumstances, which can provide insights about the technique not necessarily available in an instructional video.

If the user 114 wants to watch a sparring session or competitive match, relevant to the search criteria, the user 114 may select a video from the Sparring tab 314d, which will include a sparring session that features the searched technique, along with various other techniques. Accordingly, the user 114 may watch a sparring session looking for a technique which piques the user's interest and leads the user 114 to seek instruction on a new or previously unknown technique.

The user 114 may navigate to any desired instructional and training content available on the user interface 300 using the search and browse area 304 and the video description area 306. The techniques which may be searched include positions, transitions, attacking moves or submissions, defenses to attacks and submissions, drills or exercises, and principles. The video description area 306 and tabs 314 allow the user to navigate to a specific desired video segment based on the user's particular skill set and the user's desired area of focus. Accordingly, different users 114 may begin a training session on the user interface 300 according to their own personal taste and based on what they perceive as important areas for improvement or expansion. For example, by switching between the tabs 314, users 114 are able to both watch an instruction video segment or tutorial on a given technique and also see a vast body of different applications of that technique in live sparring sessions. If a user 114 is watching a sparring session and likes a technique they see, “advanced” and “fundamental” instructionals are just a single click away. In this way, the system may organically provide the user with the ability to move back and forth between an instructional understanding of the material and a practical understanding from the actual performance video segments. Once the user has started a training session on the user interface 300, and has located a video segment in the video description area 306 that the user wishes to view, the user selects the video segment.

As shown in FIG. 3b, upon selecting a video segment, a video display area 308 may appear on the user interface 300. The video display area 308 may include a play button, volume control, etc., which allow the user 114 to watch the selected video segment. The user 114 may have options to vary the display of the video segments, for example, by enlarging or moving the video display area 308. When the video display area 308 is ready to play or is playing a video segment, the text area 310 provides discussion and/or comments regarding the video segment in the video display area 308. Typically, a brief explanation of the substance of the video is provided, and comments may be left by users 114 discussing various aspects of the video segment. The search and browse area 304 may remain on the screen, which allows a user 114 to navigate to a different video segment using the search or browse function.

A dynamic link area 312 may be displayed which provides the user 114 with links to relevant content. As discussed in more detail below, the links may include hyperlinks, buttons, thumbnails, or the like for allowing a user 114 to review video content related to the video segment presently in the video display area 308. The dynamic link area may be dynamically updated according to the video presently on display in the video display area 308. For example, if an instructional video segment of the bow and arrow choke was selected by the user 114, when the user watches the instructional video segment for the bow and arrow choke, the dynamic link area includes links that are related to the bow and arrow instructional video segment being viewed. For example, a link to other instructional video segments relating to the bow and arrow choke may be provided, a link to In Action actual performances of the bow and arrow choke may be provided, and links to Sparring actual performances of the bow and arrow choke may be provided. The links may provide a brief description for each video segment, as well as a thumbnail, to provide the user 114 more information to determine which link to select. The links may simply be text based hyperlinks, such as those shown in FIG. 3b. For example, the hyperlink may state “Instructionals (5)” or “In Action (18)” and may vary for each video segment displayed in the video display area 308. Accordingly, the links in the dynamic link area 312 are dynamically changing based on the displayed video segment, which may be changed based on the user 114 inputs into the user interface 300.

Accordingly, for example, links to techniques that are similar to or associated with the bow and arrow choke may also be provided, such as instructional video segments for the and other actual performance video segments. Accordingly, techniques which are related to the bow and arrow choke, such as seat belt control, may be suggested as related material, which may allow the user to better grasp a full understanding of the bow and arrow choke and transitions to or from the choke. The links in the dynamic link area 312 may provide a new video segment in the video display area 308 or may provide a list of video segments in the video description area 306 which the user 114 may choose from to continue the training session.

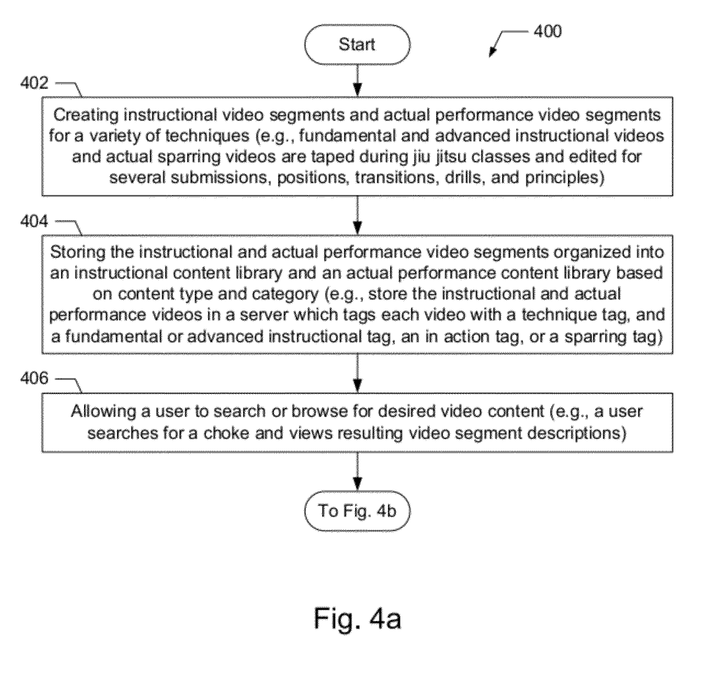

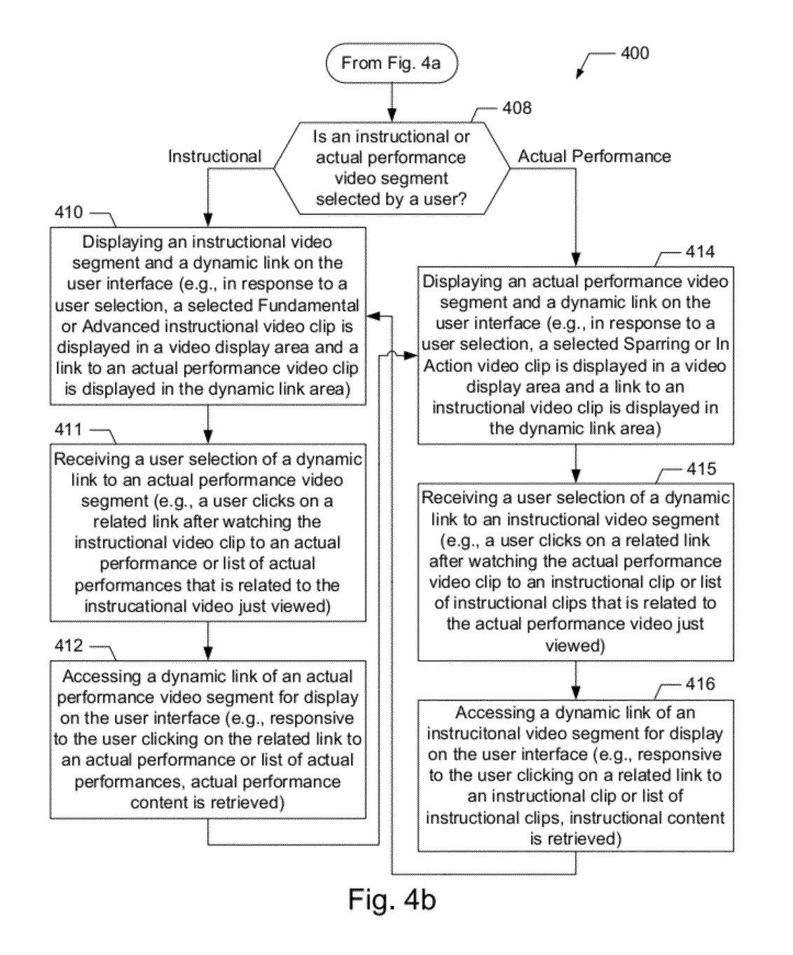

FIG. 4 is a flowchart of an example process 400 for instruction and training. Although the process 400 is described with reference to the flowchart illustrated in FIG. 4, it will be appreciated that many other methods of performing the acts associated with the process 400 may be used. For example, the order of many of the blocks may be changed, and many of the blocks described are optional.

The example process 400 may begin with creating instructional video segments and actual performance video segments for a variety of techniques (block 402). For example, fundamental and advanced instructional videos and actual sparring videos are taped during Brazilian Jiu Jitsu classes and edited for several submissions, positions, transitions, drills, and principles. An instructional video segment includes an instructional explanation, or tutorial, of a technique. The technique may include attack or submissions, positions, transitions, and defenses related to attack or submissions, positions, transitions, drills or exercises, and principles. Techniques relating to positions may include how to maintain a position or properly be in an offensive or defensive position, and techniques relating to transitions may related to switching between positions, and/or switching between attacking moves. Techniques relating to drills and exercises may include various methods for a student to develop muscle memory or the like in order to be able to properly and effectively execute a technique. Techniques relating to principles may include core concepts or theoretical ideas which are widely applicable to many techniques and positions, such as setting the tone of battle, when to rest, or filling empty space. An actual performance video segment includes any actual performance, such as a live competitive match or sparring session including an application of any technique.

For example, if a bow and arrow choke is taught in a class, the instructional on the technique may be edited into two portions, a first fundamental portion for the basic bow and arrow choke, and a second more advanced variation for more experienced students. Once a technique instruction is provided in class, students may practice the technique while sparring, and a sparring video may be edited to create a variety of In Action clips. Also, for example, video segments may be purchased or derived from existing video footage, which may be publicly available.

The instructional video segments and actual performance video segments are stored, and may be organized into an instructional content library and an actual performance content library based on content type and category (block 404). For example, the appropriately edited instructional and actual performance videos may be stored in a server, where tags created for each video include a technique tag, and a fundamental or advanced instructional tag, an in action tag, or a sparring tag. It should be appreciated that sometimes different tags for a category may be overlapping, where for example a technique may be a specific subset of another technique. Also, for example, certain video segments would be tagged with multiple tags from a certain category, such as positions. For example, a bow and arrow choke may be tagged with positions of back mount and side mount. The instructional content library and the actual performance library may be physically located separately or together, for example, in different servers (e.g., servers 226), or together in one or more servers (e.g., servers 226) which may logically distinguish between content types to provide the instructional content library and the actual performance library. The instructional content library may include many techniques for which instruction is provided, and for any given technique, there may be one or more instructional video segments which provide instruction, for example, a fundamental and an advanced video segment may provide instruction on the same technique for students of differing skill levels.

A user may be allowed to search or browse for desired video content (block 406). For example, a user searches for a choke with the search and browse area 304 of the user interface 300, and views results in the video description area 306. For example, the search may return the bow and arrow choke, which includes various instructional video segments and actual performance video segments that the user 114 may choose from. Also, for example, a user 114 may select a video without performing a search or browsing in search and browse area 304, if for example, the video description area 306 includes techniques such as recently viewed new, or randomly selected instructional video segments or actual performance video segments.

Then, an instructional video segment or actual performance video segment is selected by the user (block 408). For example, the user may click on a hyperlink, thumbnail, or button to select a video segment. In response to a communication from the client device 102, a host device 104 may provide the selected instructional video segment or actual performance video segment to a client device 102 using the internet.

Then, an instructional video segment and a dynamic link is displayed on the user interface 300 (block 410). For example, a selected Fundamental or Advanced instructional video clip, or video segment, is displayed in the video display area 308 and a link to an actual performance video clip is displayed in the dynamic link area 312. The user 114 watches the instructional video clip, and may decide that additional information is needed to fully comprehend the instruction for the technique just received. The additional information may be actual performances of the technique. The user 114 may want to see the technique applied many times without spending too much time, and may select an In Action link. The user 114 may want to see the technique applied in context to see when more experienced practitioners would use the technique and in which contexts the technique is successful. The dynamic link area 312 may include suggestions of particularly popular or useful techniques, and the related instructional or actual performance video segments.

Then, a user selection of a dynamic link to an actual performance video segment is received (block 411). For example, a user 114 clicks on a related link after watching the instructional video clip to an actual performance or list of actual performances that is related to the instructional video just viewed. For example, after searching for and viewing an advanced instructional for the bow and arrow choke, the user dynamically links to a list of all bow and arrow chokes under the In Action category to view a wide variety of different applications of the bow and arrow choke.

Then, a dynamic link is accessed for displaying an actual performance video segment on the user interface (block 412). For example, responsive to the user clicking on the related link to an actual performance or list of actual performances, actual performance content is retrieved. For example, the user dynamically links to a list of all bow and arrow chokes under the In Action category and links to a wide variety of different applications of the bow and arrow choke are retrieved from the actual content library.

Then, following a user selection from searching or browsing a technique, or resulting from the accessing of a dynamic link, an actual performance video segment and a dynamic link are displayed on the user interface 300 (block 414). For example, a selected Sparring or In Action video clip is displayed in a video display area 308 and a link to an instructional video clip is displayed in the dynamic link area 312. The user 114 watches the actual performance video clip, and may decide that additional instruction on the displayed technique, or another technique, is needed to fully employ the viewed technique. The user may look to the dynamic link area 312 to find the desired information or suggestions on further information which may be helpful.

Then, a user selection of a dynamic link to an instructional video segment is received (block 415). For example, a user 114 clicks on a related link after watching the actual performance video clip to an instructional video clip or a list of instructional video clips that is related to the actual performance video just viewed. For example, after dynamically linking to the In Action actual performances of the bow and arrow choke, the user dynamically links to an Advanced instructional video clip for seat belt control, which may provide opportunities for other techniques such as a crucifix armbar which may also be included in the instructional video clip.

Then, a dynamic link is accessed for displaying an instructional video segment on the user interface (block 416). For example, responsive to the user 114 clicking on the related link to an instructional video clip or a list of instructional video clips, instructional content is retrieved. For example, the user dynamically links to an Advanced instructional video clip for seat belt control, which may retrieve the Advanced instructional video clip which may include other techniques such as a crucifix armbar. Accordingly, as a result of the user selection of the dynamic link, the accessed instructional video content may be displayed with a dynamic link on the user interface (block 410).

Accordingly, the user may dynamically link from an instructional video segment to an actual performance video segment, and then, may dynamically link from the actual performance video segment to another instructional video segment, or vice versa. The user 114 may continue dynamically accessing content from the instructional content library and the actual performance content library as the user desires based on the information which is being digested. For example, a user may want to work on improving a particular position, such as back position, which may lead to learning a submission from an instructional related to the back position, which may lead to viewing actual performance of an attempt of the submission, which may alert the user to a defense of the submission and its typical uses, which may lead to reviewing an instructional of the defense, which may include a transition, which may lead to viewing actual performance of the transition, and so on. The user or student may learn in a natural and fluid manner, going back and forth between instructional content and actual performance content. It should be appreciated that the actual performance content may provide insight different from the instructional content, and the instructional content may provide insight different from the actual performance content. For example, seeing a technique spontaneously applied in an adverse situation may provide insights that are not apparent in an instructional setting, and seeing a technique applied several times in different settings may provide a fuller understanding than an instructional setting.

Further, additional analysis may be provided in, for example, the dynamic link area 312 or video description area 306. For example, success rates in the form of probabilities may be provided for some or all techniques. Also, a measure of how often a typical opponent, or a superior opponent, will perform a technique in a given situation may be provided. Such analytics may provide a user 114 with a particularly deep understanding of which techniques are best, and which techniques the user 114 should spend time learning and training.

Also, it should be appreciated that, while the process 400 typically may use a network 106 to provide a client device 102 with the content for display to a user 114, it should be appreciated that in an example embodiment, the process 400 may be performed in a host device 104 acting as a stand alone terminal which does not send or receive data over a network 106.

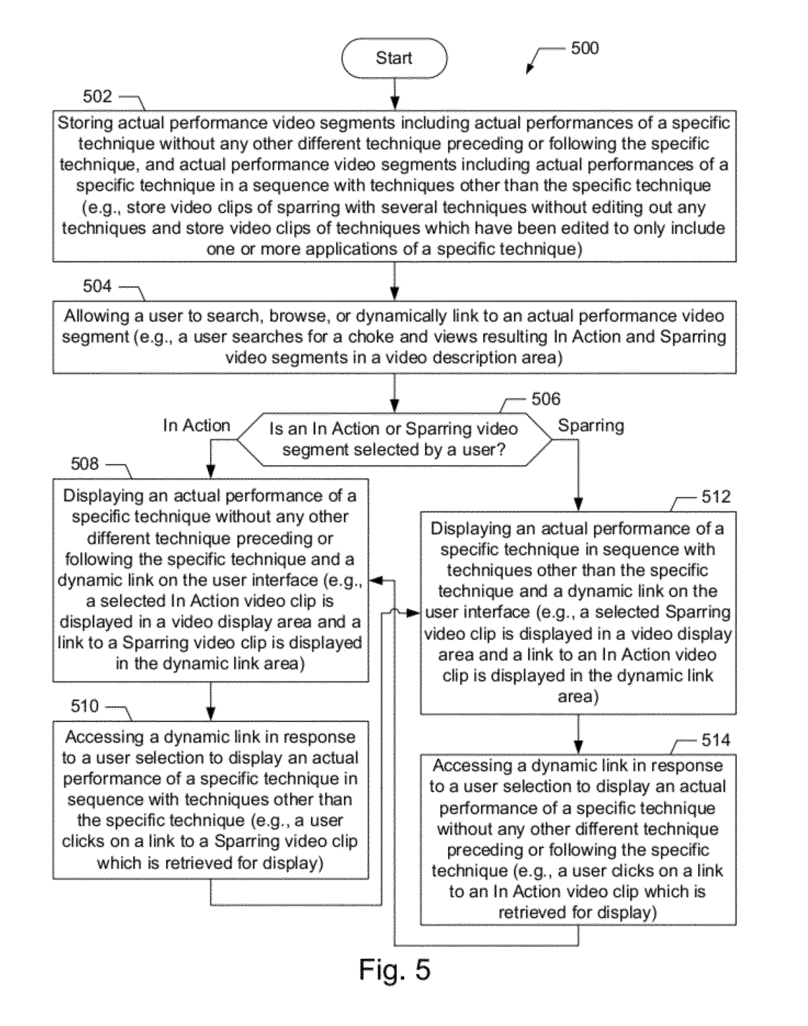

FIG. 5 is a flowchart of an example process 500 for instruction and training. Although the process 500 is described with reference to the flowchart illustrated in FIG. 5, it will be appreciated that many other methods of performing the acts associated with the process 500 may be used. For example, the order of many of the blocks may be changed, and many of the blocks described are optional.

The example process 500 may begin by storing actual performance video segments including actual performances of a specific technique without any other different technique preceding or following the specific technique, and actual performance video segments including actual performances of a specific technique in a sequence with techniques other than the specific technique (block 502). For example, video clips of sparring sessions including several techniques are stored, without editing out any techniques from the sparring session, and video clips of single techniques are stored, which have been edited to only include one or more applications of a specific technique. An actual performance content library may include a plurality of techniques with one or more In Action video clips and one or more Sparring video clips.

A user is allowed to search, browse, or dynamically link to an actual performance video segment (block 504). For example, a user searches for a choke and views resulting In Action and Sparring video segments in a video description area 306. The In Action video segments results may be displayed under a tab 314c, while the Sparring video segments results may be displayed under a tab 314d. The user may select an In Action actual performance video segment or a Sparring actual performance video segment (block 506).

An actual performance video segment including an actual performance of a specific technique without any other different technique preceding or following the specific technique is displayed and a dynamic link is displayed on the user interface 300 (block 508). For example, a selected In Action video clip is displayed in a video display area 308 and a link to a Sparring video clip is displayed in the dynamic link area 312. Then, a dynamic link is accessed in response to a user selection to display an actual performance of a specific technique in sequence with techniques other than the specific technique (block 510). For example, a user clicks on a link to a Sparring video clip which is retrieved for display.

Then, in response to a selection or dynamic linking, an actual performance video segment including an actual performance of a specific technique in sequence with techniques other than the specific technique is displayed and a dynamic link is displayed on the user interface 300 (block 512). For example, a selected Sparring video clip is displayed in a video display area 308 and a link to an In Action video clip is displayed in the dynamic link area 312. Then, a dynamic link is accessed in response to a user selection to display an actual performance of a specific technique without any other different technique preceding or following the specific technique (block 514). For example, a user clicks on a link to an In Action video clip, which is retrieved for display.

Accordingly, the user 114 may maneuver between In Action actual performances and Sparring actual performances. This may allow a user to review actual performances to look for ideas that may be worth studying, and then diving deeper into such ideas. For example, a user 114 may watch sparring sessions until some technique they are unfamiliar with catches the user's eye, and then watch several applications of the unfamiliar technique to determine whether it would be worthwhile to study an instructional video segment of the technique.

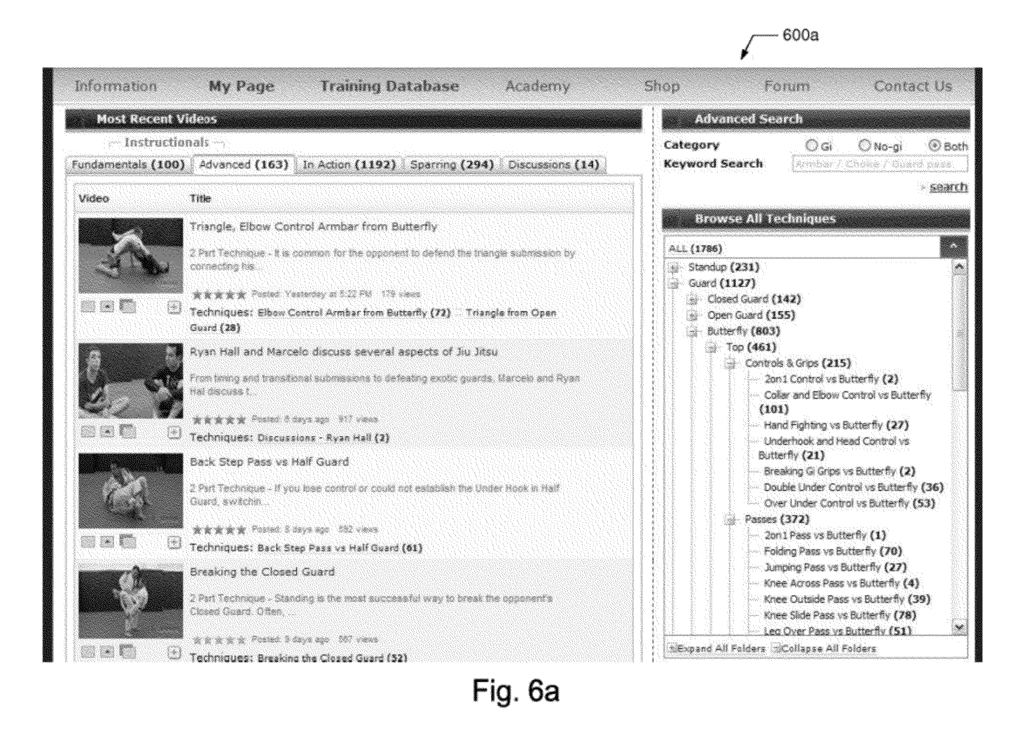

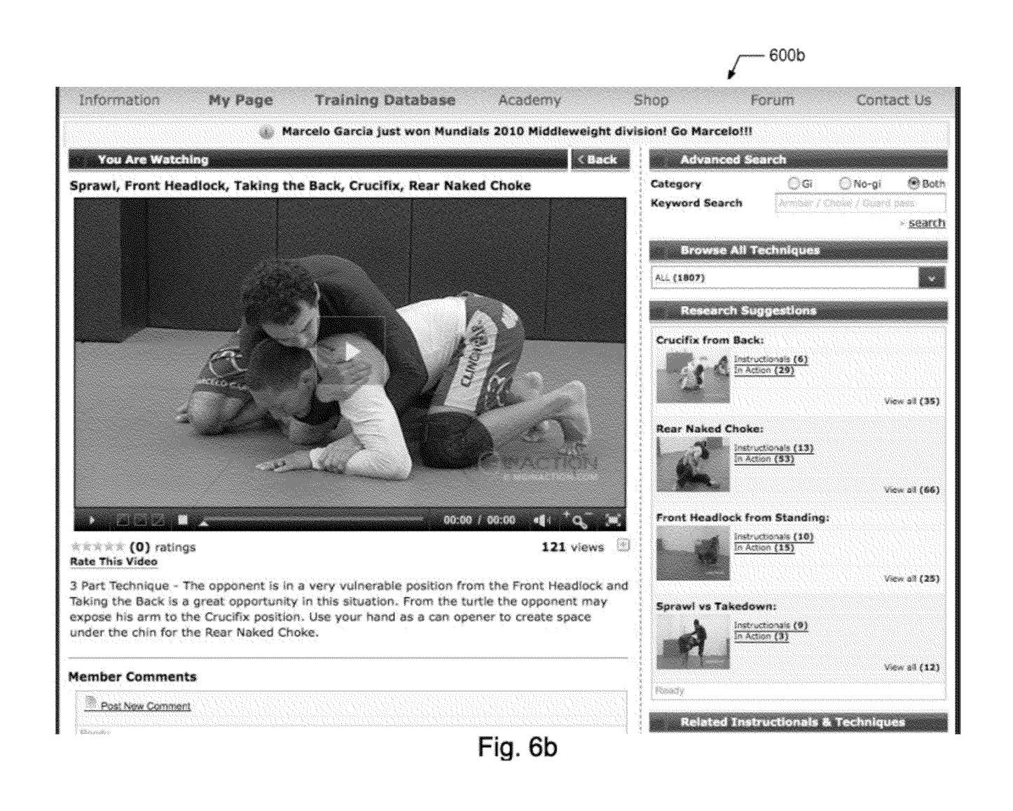

FIGS. 6a and 6b provide screen shots of an example user interface. FIGS. 6a and 6b illustrate how a user interface may display a web page 600a for training students in Brazilian Jiu Jitsu. Similar to FIG. 3a discussed above, the web page 600a includes a website content area, a search and browse area, and a video description area with various tabs. Similar to FIG. 3b discussed above, FIG. 6b shows a web page 600b includes a video display area 308, a text area 310, a search and browse area 304, and a dynamic link area 312.

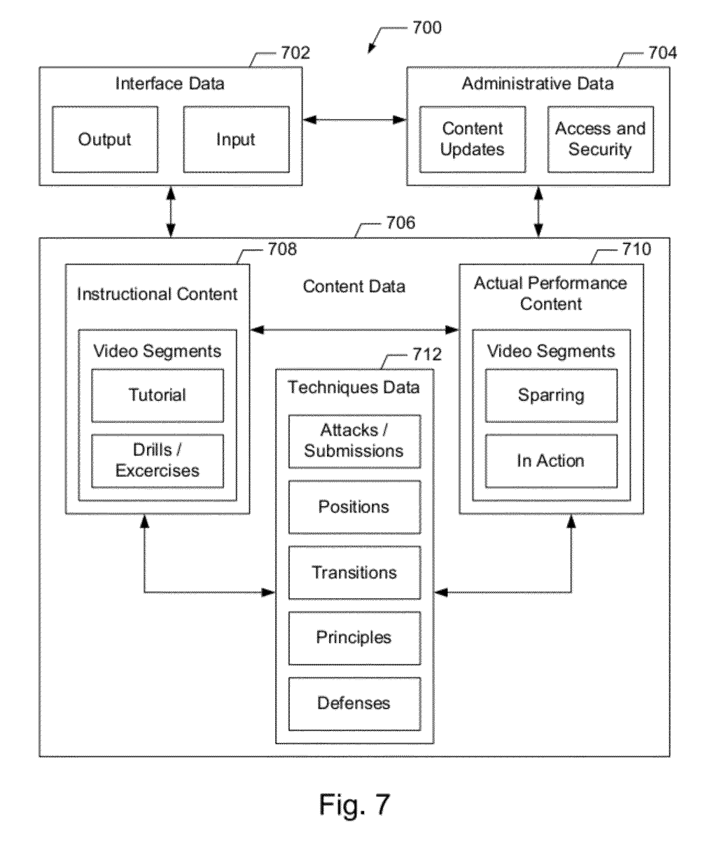

FIG. 7 illustrates a block diagram of an example data architecture 700. In the example data architecture 700, interface data 702, administrative data 704, and content data 706 interact with each other, for example, based on user commands or requests. The interface data 702, administrative data 704, and content data 706 may be stored on any suitable storage medium (e.g., server 226). It should be appreciated that different types of data may use different data formats, storage mechanisms, etc. Further, various applications may be associated with processing interface data 702, administrative data 704, and content data 706. Various other or different types of data may be included in the example data architecture 700.

Interface data 702 may include input and output data of various kinds. For example, input data may include mouse click data, scrolling data, hover data, keyboard data, touch screen data, voice recognition data, etc., while output data may include video data, audio data, image data, text data, etc. Interface data 702 may include request data, suggestion data, survey data, advertising data, and the like. Interface data 702 may include applications used to provide or monitor interface activities and handle input and output data.

Administrative data 704 may include content update data and applications for updating content data or data related to content. Further, administrative data 704 may include access data and/or security data. Administrative data 704 may interact with interface data in various manners, providing a user interface with administrative features, such as implementing a user login, gathering user statistics, providing advertising content, and the like.

Content data 706 may include various types of content, for example, instructional content 708, actual performance content 710, and techniques 712. Content data 706 may be stored and/or organized within a relational database system. It should be appreciated that different content data types may be stored in accordance with system requirements. For example, video segments may be stored in a video server, while relational tagging data may be stored in a database server. The instructional content 708 and actual performance content 710 may each include video segments, as well as other content. Instructional content 708 may include tutorial video segments and/or drills or exercise video segments. Actual performance content 710 may include sparring video segments and/or in action video segments. Techniques data 712 may include data regarding techniques to be trained or learned. The video segments are typically organized and indexed according to a predetermined scheme. For example, each video segment may be tagged with techniques data 712, such as one or more tags for attacks or submissions, positions, transitions, principles, and/or defenses. It should be appreciated that content data of various types may be related to other content data. For example, administrators may provide and/or update content relationships (e.g., using a relational database), which are used by users to dynamically link between instructional content 708 and actual performance content 710 using techniques data 712. It should be appreciated that content data structures, data format, and data relations may be provided in a many suitable fashions, using a variety of data transfer protocols and data processing techniques. Moreover, the example data architecture 700 is provided as an exemplary data architecture for an example embodiment using martial or self defense techniques, such as Brazilian Jiu Jitsu. It should be appreciated that a data architecture may be tailored to each subject or skill set for which training or instruction may be provided.

Although for exemplary purposes, the present disclosure discusses the instruction and training of Brazilian Jiu Jitsu, however, the disclosed system may be applied to anything which requires instruction or training. A non-limiting list of examples includes sports and games such as tennis, football, basketball, hockey, volleyball, billiards, darts, poker, bridge, blackjack, chess, backgammon, or other martial arts including boxing, wrestling, judo, kick boxing, recreational activities such as dancing, sailing, fishing, gardening, playing music, or yoga, vocational applications such as welding, culinary, cooking, cultivation, aviation, medical, surgical, dental, massage therapy, glass blowing, military training, or mining, and many other areas of life. The present disclosure may be particularly helpful in dangerous or competitive applications which require repeated decisions of how to further proceed at many instances in a given process.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
storing an instructional content library including a first plurality of instructional video segments including a first instructional video segment including instruction on a first technique and a second plurality of instructional video segments including a second instructional video segment including instruction on a second technique;
storing an actual performance content library including a first plurality of actual performance video segments including a first actual performance video segment including at least one actual performance of the first technique and a second plurality of actual performance video segments including a second actual performance video segment including at least one actual performance of the second technique; and
at least one of:
(i) causing a user interface to display the first instructional video segment and a first dynamic link to the first plurality of actual performance video segments, accessing the first dynamic link in response to a first user selection, and causing the user interface to display the first actual performance video segment following the display of the first instructional video segment; and
(ii) causing the user interface to display the second actual performance video segment and a second dynamic link to the second plurality of instructional video segments, accessing the second dynamic link in response to a second user selection, and causing the user interface to display the second instructional video segment following the display of the second actual performance video segment.

2. The method of claim 1, wherein instructional content is martial arts instruction, and actual performance content is at least one of competitive sparring and actual combat.

3. The method of claim 1, wherein all instructional video segments are displayed in an instructional video display area and all actual performance video segments are displayed in an actual performance video display area.

4. The method of claim 3, wherein the instructional display area and the actual performance display area are located on the user interface in different areas.

5. The method of claim 3, wherein the instructional display area and the actual performance display area are located on the user interface in the same area and instructional video segments and actual performance segments are sequentially displayed.

6. The method of claim 1, wherein the first technique is at least one of an attack, a submission, a position, and a transition.

7. The method of claim 1, wherein the first technique is at least one of a drill and an exercise.

8. The method of claim 1, wherein the first technique is a principle.

9. The method of claim 1, wherein the first actual performance video segment includes at least one of a sparring session and a competitive match, which includes an actual performance of the first technique.

10. The method of claim 1, wherein the first actual performance video segment includes a plurality of different applications of the first technique in sequence.

11. The method of claim 1, wherein a user accesses a plurality of dynamic links to navigate between corresponding instructional video segments from the instructional video content library and actual performance video segments from the actual performance content library.

12. The method of claim 1, wherein the first instructional video segment is tagged as relating to the first technique, the second instructional video segment is tagged as relating to the second technique, the first actual performance video segment is tagged as relating to the first technique, and the second actual performance video segment is tagged as relating to the second technique.

13. The method of claim 1, wherein a third instructional video segment is added to the instructional content library, and the third instructional video segment is tagged according to at least one of the first technique, the second technique, and a third technique.

14. The method of claim 1, wherein a third actual performance video segment is added to the actual performance content library, and the third actual performance video segment is tagged according to at least one of the first technique, the second technique, and a third technique.

15. The method of claim 1, wherein all video segments included in the instructional content library and the actual performance content library are tagged with at least one of a technique tag, a position tag, a transition tag, and a principle tag.

16. (canceled)

17. A method comprising:
displaying on a user interface at least one of:
(i) a first instructional video segment from an instructional content library including a first plurality of instructional video segments including the first instructional video segment including instruction on a first technique, and a first dynamic link to access at least one actual performance of the first technique from an actual performance content library; and
(ii) a first actual performance video segment from the actual performance content library including a first plurality of actual performance video segments including the first actual performance video segment including at least one actual performance of a second technique, and a second dynamic link to access instruction on the second technique from the instructional content library;
accessing at least one of the first dynamic link and the second dynamic link in response to a user selection; and
at least one of:
(iii) displaying on the user interface, in response to the user selection, a second actual performance video segment from the actual performance content library including a second plurality of actual performance video segments including the at least one actual performance of the first technique; and
(iv) displaying on the user interface, in response to the user selection, a second instructional video segment from the instructional content library including a second plurality of instructional video segments including the instruction on the second technique.

18. A method comprising:
storing an actual performance content library including a first actual performance video segment including at least one actual performance of a first technique without any other different technique preceding or following the first technique, a second actual performance video segment including at least one actual performance of a second technique without any other different technique preceding or following the second technique, a third actual performance video segment including one actual performance of the first technique in a sequence with a plurality of techniques other than the first technique, and a fourth actual performance video segment including one actual performance of the second technique in a sequence with a plurality of techniques other than the second technique; and
at least one of:
(i) causing a user interface to display the first actual performance video segment and a first dynamic link to the third actual performance video segment, accessing the first dynamic link in response to a first user selection, and causing the user interface to display the third actual performance video segment following the display of the first actual performance video segment; and
(ii) causing the user interface to display the fourth actual performance video segment and a second dynamic link to the second actual performance video segment, accessing the second dynamic link in response to a second user selection, and causing the user interface to display the second actual performance video segment following the display of the fourth actual performance video segment.

19. The method of claim 18, wherein the first actual performance video segment includes a plurality of actual performances of the first technique in succession.

20. The method of claim 18, wherein the third actual performance video segment includes the one actual performance of the first technique preceded by a third technique and followed by a fourth technique.

21. The method of claim 18, further comprising:
causing the user interface to display a third dynamic link to an instructional video segment;
accessing the third dynamic link in response to a third user selection; and
causing the user interface to display the instructional video segment following the display of at least one of the second actual performance video segment and the third actual performance video segment.

22-86. (canceled)
